(19) United States
(12) Patent Application Publication
(10) Pub. No.: US 2009/0035477 A1
(43) Pub. Date: Feb. 5, 2009

(54) Masks and Related Methods for Repairing Gas Turbine Engine Components

(75) Inventor: Mark E. Addis, Kennebunk, ME (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UNITED TECHNOLOGIES CORP., Hartford, CT (US)

(21) Appl. No.: 11/830,103

(22) Filed: Jul. 30, 2007

(51) Int. Cl. B05D 1/32; B05C 13/02

(52) U.S. Cl. 427/448; 427/142; 428/603

(57) ABSTRACT

Masks and related methods for repairing a gas turbine engine components are provided. A representative method includes using a self-coiling strip of material as a mask during application of a coating to a surface of the component.

### BACKGROUND

1. Technical Field

This disclosure generally relates to gas turbine engine repair.

2. Description of the Related Art

Various components of gas turbine engines can degrade over time, such as by wear and/or oxidation. In this regard, various overhaul procedures have been developed to restore components that have been degraded. For those components that are coated, the coatings typically are removed in order to prepare the surfaces of the components for receiving new coatings. However, care should be used in order to avoid further damaging the components during application of harsh surface treatments that are typically used to remove the old coatings.

### SUMMARY

Masks and related methods for repairing gas turbine engine components are provided. In this regard, an exemplary embodiment of a method comprises using a self-coiling strip of material as a mask during application of a coating to a surface of the component.

Another exemplary embodiment of a method comprises: providing a self-coiling strip of material; positioning the strip of material at a masking location of the component such that the strip of material coils and is retained at the masking location; and applying a coating to the surface of the component such that the strip of material inhibits coating at the masking location.

An exemplary embodiment of a mask for use in repair of a gas turbine engine component comprises a re-usable strip of self-coiling material.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a schematic diagram of a representative gas turbine engine component.

FIG. 2 is a schematic diagram depicting an embodiment of a mask.

FIG. 3 is a schematic, cross-sectional, cutaway view showing detail of the embodiment of the component of FIG. 1.

FIG. 4 is a flowchart depicting an embodiment of a method for repairing a gas turbine engine component.

FIG. 5 is a flowchart depicting another embodiment of a method for repairing a gas turbine engine component.

### DETAILED DESCRIPTION

Gas turbine engine component repair methods and related systems are provided. In this regard, several exemplary embodiments will be described. In particular, some of these embodiments involve the use of a self-coiling strip of material as a mask during performance of coating application and/or stripping procedures. Notably, the self-coiling feature potentially results in a significant labor savings compared to prior art techniques that typically involve manual taping-off of locations that are to be masked. Additionally, by using a self-coiling mask, the masks can accommodate a range of component diameters. Thus, in addition to being re-usable, some embodiments can be used on components of different sizes.

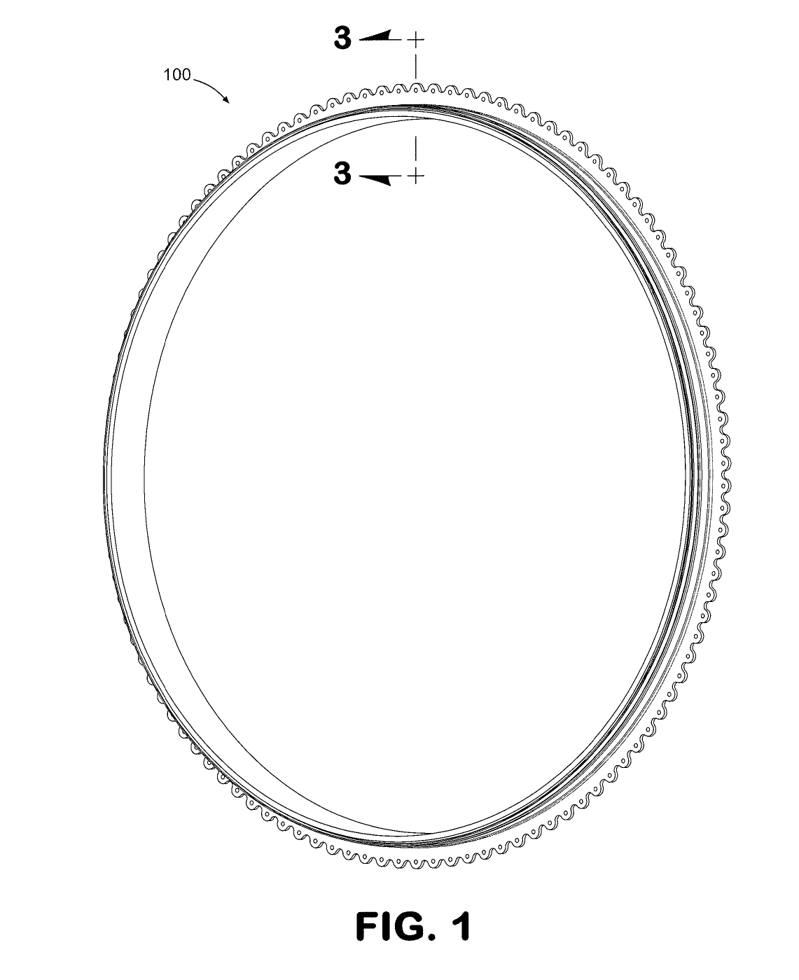

Referring now in more detail to the drawings, FIG. 1 is a schematic diagram depicting a representative gas turbine engine component. Specifically, FIG. 1 depicts an embodiment of a high-pressure compressor outer air seal 100. Notably, component 100 has been previously coated, such as with plasma spray, and it is now desired that the component be stripped of that coating and recoated.

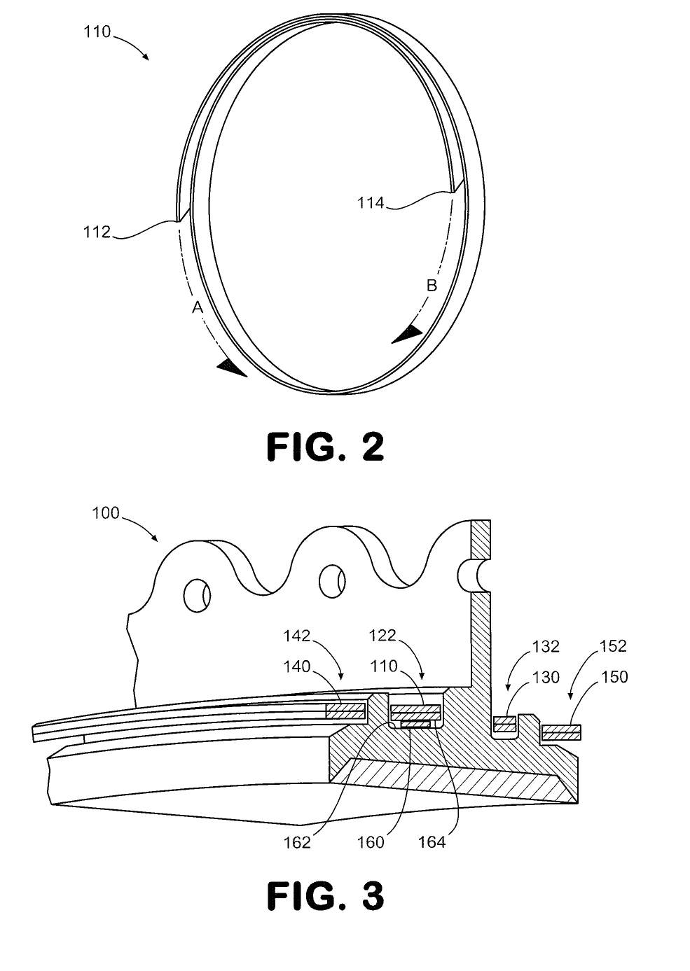

In this regard, FIG. 2 schematically depicts an embodiment of a mask than can be used during stripping and/or applying of a coating to a component, such as the component depicted in FIG. 1. As shown in FIG. 2, the mask 110 comprises a strip of material that is configured to coil upon itself as indicated by arrows A and B. In particular, the strip of material is of adequate length in this embodiment such that ends 112, 114 of the strip tend to overlap each other when the strip of material is in a relaxed state, although in other embodiments, the ends may not overlap. Notably, such a self-coiling mask exhibits a relaxed state from which the mask can be further coiled or uncoiled. When uncoiled from the relaxed state, the mask tends to exert a constrictive (inward) force, which can be used to retain the mask in position about an exterior of a component, for example. In contrast, when further (more tightly) coiled from the relaxed state, the mask tends to exert an expansive (outward) force, which can be used to retain the mask in position within a cavity of a component, for example.

Although capable of being formed of various materials, the embodiment of FIG. 2 is formed of metal, which provides suitable strength and heat resistance properties that enable the strip to be used as a mask during a stripping procedure as well as a coating procedure. In this regard, such a stripping procedure can include stripping of a coating by water jet, whereas such a coating procedure can include coating by a plasma spray coating process. In some embodiments, the metal can be spring steel, for example.

FIG. 3 schematically depicts a cross-sectional cutaway view of the component 100 of FIG. 1 shown with the mask 110 of FIG. 2 and several additional masks positioned about the component. Specifically, mask 110 is positioned within a first annular recess 122 of the component. Mask 110 is so positioned in order to mask a first masking location (located between an upper surface of the mask and lower portions of the recess) that is not to receive application of a coating. This also defines a first coating location, which is located radially outwardly from the upper surface of the mask. Additionally, a second mask 130 is located in a second annular recess 132 of the component to mask a second masking location while defining a second coating location. A third mask 140 is located about an annular end 142 of the component to mask a third masking location while defining a third coating location. A fourth mask 150 is located about the other annular end 152 of the component to mask a fourth masking location while defining a first coating location.

Note that, in the embodiment of FIG. 3, a support 160 is positioned between an outer surface 162 of the component that defines a portion of recess 122 and an inner diameter 164 of the first mask. Support 162 is used to radially position the first mask with respect to the component in order to radially define the first masking location and the corresponding first coating location. Clearly, various sizes and shapes of supports, such as continuous strips or supports intermittently placed about the component, can be used.

Following a stripping and/or coating operation, the masks can be removed, after which, any raised edges that may occur at the edges of the masking locations can be blended. Notably, since the masks are self-coiling, each can be used on another component exhibiting different dimensions. That is, since each mask is self-adjusting among a range of components sizes, each mask is not limited to use with a particularly sized component.

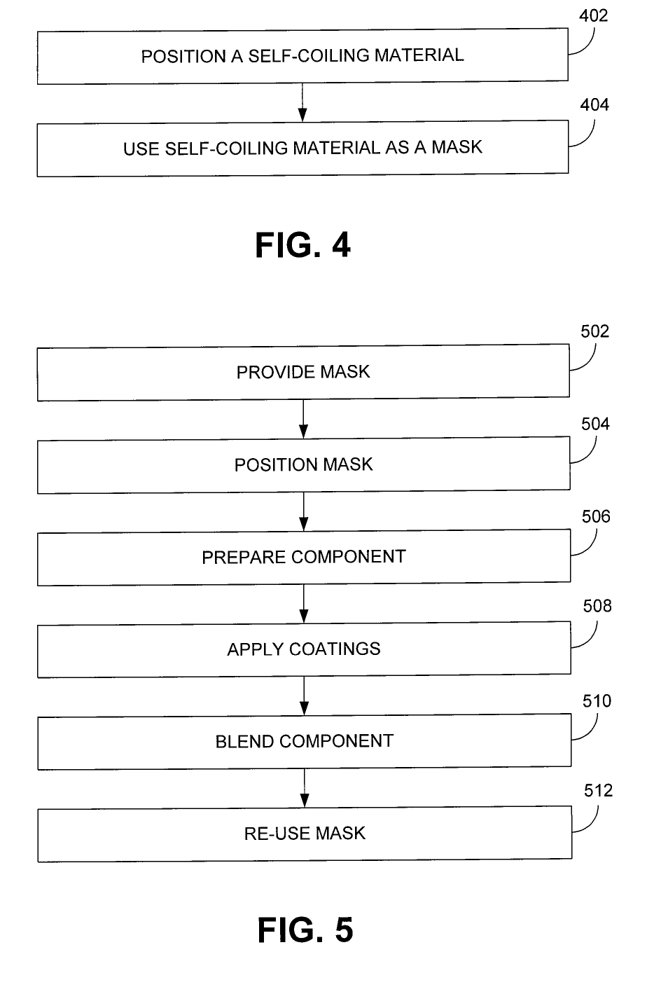

FIG. 4 is a flowchart depicting functionality of an embodiment of a method for repairing a gas turbine engine component. In this regard, the method may be construed as beginning at block 402 in which a self-coiling strip of material is positioned with respect to a component. Then, in block 404, the self-coiling strip of material is used as a mask, such as during application of a coating to a surface of the component. Notably, the surface can be an inner or outer surface. With respect to an outer surface, in some embodiments, coiling of the mask about the component tends to retain the mask at the mask location as compressive forces are exerted to the component by the mask. Retention of the mask also can be accomplished when used with inner surfaces. However, for an inner surface, the ability of the mask to exert outward pressure against the surface may be that which retains the mask at the masking location.

FIG. 5 is a schematic diagram depicting another embodiment of a method for repairing a gas turbine engine component. As shown in FIG. 5, the method may be construed as beginning at block 502, a self-coiling strip of material (or mask) is provided. For instance, the mask can be formed of spring steel and of such a length that the ends of the strip overlap each other when positioned about the component at a masking location. In block 504, the mask is positioned about the component at a masking location. In some embodiments, the mask coils about the component in such a manner that the position of the mask is maintained at the masking location without the use of other provisions, such as tape of clamps. Notably, the masking location typically is an annular region about the component that corresponds to the physical characteristics of the mask. That is, the width of the mask typically corresponds to the desired width of the masking location and the length of the mask typically is sufficient to permit overlap of the ends of the mask when positioned about the masking location.

In block 506, a surface of a component is prepared. By way of example, the surface can be prepared by stripping a previously applied coating, such as by using a water jet. In other embodiments, other surface treatments can be performed. Notably, stripping of a component can be performed without the mask being in the masking location in some embodiments, e.g., the entire component can be subjected to stripping.

In block 508, one or more coatings are applied to the surface of the component while the mask is positioned at the masking location. As such, the mask inhibits the coating(s) from being applied at the masking location. Thereafter, such as depicted in block 510, the surface of the component can be blended to remove any unwanted edges or transitions that may occur between the coating(s) and the surface of the component. Typically, such blending is performed after the mask is removed. In block 512, the mask is used on another component.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. All such modifications and variations are intended to be included herein within the scope of this disclosure and protected by the accompanying claims.

1. A method for repairing a gas turbine engine component comprising:
providing a self-coiling strip of material;
positioning the strip of material at a masking location of the component such that the strip of material coils and is retained at the masking location; and
applying a coating to the surface of the component such that the strip of material inhibits coating at the masking location.

2. The method of claim 1, wherein the surface is an outer surface.

3. The method of claim 1, further comprising preparing the surface of the component.

4. The method of claim 3, wherein:
the preparing is performed after the strip of material is positioned; and
the preparing comprises removing a previously applied coating.

5. The method of claim 4, wherein the preparing comprises stripping the surface using a water jet.

6. The method of claim 1, wherein the strip of material is a strip of spring steel.

7. The method of claim 1, wherein the positioning comprises positioning the strip of material annularly about the component.

8. The method of claim 1, wherein the component is an outer air seal of a gas turbine engine.

9. The method of claim 1, wherein the applying comprises plasma spray coating the surface of the component.

10. The method of claim 1, wherein:
the component is a first component and exhibits a first outer diameter; and
the method further comprises using the strip of material as a mask for a second component exhibiting a second outer diameter different than the first outer diameter.

11. The method of claim 1, further comprising positioning a support between the surface of the component and the strip of material such that radial positioning of the masking location is accommodated.

12. A method for repairing a gas turbine engine component comprising:
using a self-coiling strip of material as a mask during application of a coating to a surface of the component.

13. The method of claim 12, further comprising preparing the surface of the component prior to the application of the coating.

14. The method of claim 13, wherein the preparing comprises removing a previously applied coating from the surface of the component.

15. The method of claim 12, wherein the using comprises using the self-coiling strip of material as a mask during plasma spray coating of the surface of the component.

16. The method of claim 12, wherein the using comprises positioning a support between the surface of the component and the self-coiling strip of material such that the support establishes a radial position of the self-coiling strip of material in a vicinity of the support.

17. The method of claim 12, further comprising using the self-coiling strip of material as a mask during application of a coating to a surface of a second component.

18. A mask for use in repair of a gas turbine engine component, said mask comprising:
a re-usable strip of self-coiling material.

19. The mask of claim 18, wherein the material is metal and exhibits an uncoiled length at least equal to the perimeter of a component about which the mask is to be positioned.

20. The mask of claim 18, wherein the material is spring steel.
